(19) United States
(12) Patent Application Publication
(10) Pub. No.: US 2018/0365079 A1
(43) Pub. Date: Dec. 20, 2018

(54) COOPERATIVE DATA MIGRATION FOR STORAGE MEDIA

(71) Applicant: Burlywood, LLC, Longmont, CO (US)

(72) Inventors: Nathan Koch, Longmont, CO (US); Tod Roland Earhart, Longmont, CO (US); Erik Habbinga, Fort Collins, CO (US); Christopher Bergman, Erie, CO (US); David Christopher Pruett, Longmont, CO (US); John Slattery, Boulder, CO (US)

(21) Appl. No.: 16/008,187

(22) Filed: Jun. 14, 2018

Related U.S. Application Data
(60) Provisional application No. 62/519,268, filed on Jun. 14, 2017.

(51) Int. Cl. G06F 9/50; G06F 3/06

(52) U.S. Cl. CPC G06F 9/5083; G06F 3/0673; G06F 3/0647; G06F 3/0604

(57) ABSTRACT

A storage system is provided. The storage system includes a workload manager with visibility to host data operations for a storage drive. The workload manager is configured to determine an operation schedule comprising the host data operations and data migration operations for storage media of the storage drive, and instruct a storage media manager to perform the data migration operations and the host data operations in accordance with the operation schedule. The storage system also includes a storage media manager configured to receive instructions from the workload manager in accordance with the operation schedule, and responsively perform the data migration operations and the host data operations.

### RELATED APPLICATIONS

This application hereby claims the benefit of and priority to U.S. Provisional Patent Application No. 62/519,268, titled “COOPERATIVE DATA MIGRATION”, filed on Jun. 14, 2017, and which is hereby incorporated by reference in its entirety.

### BACKGROUND

Solid state storage drives (SSDs) incorporate various solid-state storage media, such as NAND flash or other similar storage media, and typically require various low-level media maintenance activities to compensate for limitations of the underlying physical storage media. These media maintenance activities can include garbage collection, wear leveling, data staling avoidance, or other maintenance activities. Maintenance activities must typically co-exist with data operations, such as read/write/erase data operations initiated by host activity, user applications, operating system functions, and the like. Currently, media maintenance activities of SSDs are handled by low-level drive electronics or processor elements which can clash with the data operations initiated by host systems. This can lead to inefficiencies, excessive media wear, and write amplification, as media maintenance activities may involve moving excess data or occur during inopportune times.

### Overview

A storage system is provided. The storage system includes a workload manager with visibility to host data operations for a storage drive. The workload manager is configured to determine an operation schedule comprising the host data operations and data migration operations for storage media of the storage drive, and instruct a storage media manager to perform the data migration operations and the host data operations in accordance with the operation schedule. The storage system also includes a storage media manager configured to receive instructions from the workload manager in accordance with the operation schedule, and responsively perform the data migration operations and the host data operations.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a data storage system in an example implementation.

FIG. 2 illustrates a data storage flow in an example implementation.

FIG. 3 illustrates a method of operating a data storage system in an example implementation.

FIG. 4 illustrates a method of operating a data storage system in an example implementation.

FIG. 5 illustrates a storage controller in an example implementation.

### DETAILED DESCRIPTION

Solid state storage drives (SSDs) incorporate various solid-state storage media, such as NAND flash or other similar storage media, and typically require various low-level media maintenance activities to support data storage and retrieval operations. These media maintenance activities can include data migration activities, which comprises data movement to different storage media locations. Data migration activities include garbage collection, wear leveling, data staling avoidance, or other data/media maintenance activities. For purposes of illustration, NAND flash storage media is discussed herein. But it should be understood that other forms of storage media can be employed and managed in a similar way. Flash storage media is usually managed by writing to groups of logical blocks, sometimes known as superblocks and referred to herein as to allocation units (AUs). An allocation unit refers to a granular unit at which a media management entity allocates physical media for writing new data and erasing invalidated data.

Data within an allocation unit may need to be migrated to new allocation units for a variety of reasons. In a first example of data migration, most of the data in the allocation unit has either been re-written by a host system or trimmed/erased and has become invalid. The remaining valid data is then moved and compacted to free up allocation units, which are subsequently used for receiving/storing new data. This first type of data migration is known as garbage collection. In a second example of data migration, data in an allocation unit is unstable and data is moved to a more stable location. This unstable data can be due to read disturb activities, such as by reading of some areas of flash that can affect the stability of surrounding areas. This unstable data can instead be due to data retention issues when data has been stored in the same location for a long time. In a third example of data migration, data in an allocation unit is cold due to being written at a past time older than a target time, but resides in a storage area with a low program/erase cycle count. This cold data then can be moved to a block with a high program/erase cycle count. This third example of data migration is referred to as wear-leveling.

SSDs can migrate data autonomously which does not provide the ability to finely interleave new data with data migration activities, or the ability to take into consideration a known future storage workload. This can lead to incorrect decisions and/or disruption in performance when not desired. If new data continues to arrive for storage by the storage media while data is being migrated, then the data migration activities can negatively affect performance of an associated storage drive since bandwidth resources are consumed by the data migration activities. Furthermore, if data that is being migrated is about to be re-written, migrations occur that could have been avoided. SSDs can attempt to make these decisions based on workload heuristics, but workload heuristics do not have predict future workloads or the specific user application or storage niche in which data activities have been deployed.

In addition, many systems have multiple layers of garbage collection due to a log structured file system. In these cases, many times a SSD will perform garbage collection at a media management layer while additional garbage collection is being performed at the workload management layer, leading to inefficiencies and write amplification, as excess data may be moved. The examples herein advantageously allow the various garbage collection functions to be collapsed into a single function in an enhanced workload management layer, resulting in reduced write amplification, increased storage device performance, and reduced media wear.

Some storage protocols, such as used on embedded multi-media cards (eMMC), provide an interface for a storage device to communicate an urgency of data migrations, as well as the ability to entirely disable data migrations. However, eMMC features may still result in excess data being moved, and fail to handle efficient co-existence with host data operations. For example, eMMC devices might allow garbage collections happen at opportune times, but eMMC devices do not give the same flexibility as the enhanced workload management layer discussed herein to select which data a storage device wants to migrate, the ability to interleave data streams, and the ability understand allocation unit boundaries.

Thus, the enhanced workload management layer discussed herein can determine which data migrations will result in media being freed up and erased, and optimize data migrations accordingly. Moreover, the enhanced elements discussed herein separate aspects of data storage that storage devices are best suited, such as physical media management, from the aspects of data storage that the traffic generating entity is the best at, such as workload management. A workload indicates a data stream and associated characteristics. For example, workloads comprise sequential write operations, random write operations, mixed read/write operations, as well as their distribution in time. The enhanced workload management layer discussed herein can apply knowledge of past, current and future workloads, using knowledge of storage media wear and data retention statistics monitored by physical media management elements. The workload management layer can improve actions about when to migrate data (such as when a burst of new data ends), and what data to migrate (such as holding off on migrating data that is going to be re-written in the near future). A media management layer is provided that indicates physical media information to the workload management layer to allow the workload management layer to make better data migration choices based on the workload. Of all the reasons to migrate data, the one that is more dependent on workload is garbage collection. Consequently, the selection of which data to garbage collect is best handled by the workload management layer and not a low-level physical media entity. However, physical media knowledge, such as allocation unit boundaries, is employed by the workload management layer to write data and pick an allocation unit with the smallest number of valid data blocks to migrate, thereby freeing up media locations with the fewest number of data block migrations.

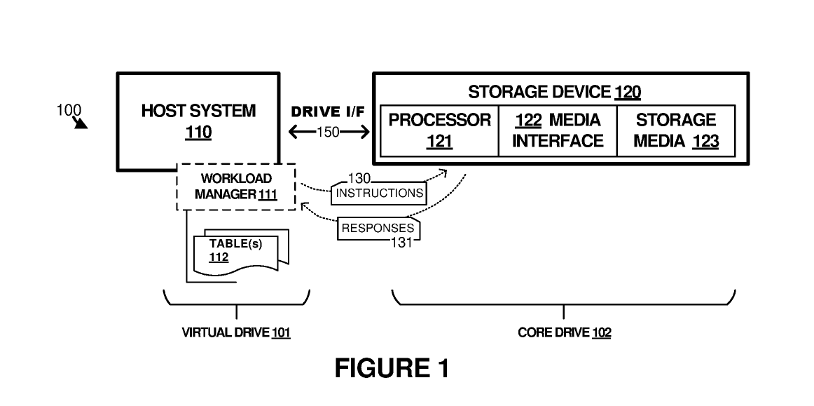

FIG. 1 is now presented as a first example system which employs enhanced storage workload management features. FIG. 1 illustrates data storage system 100 in an example implementation. In FIG. 1, host system 110 is communicatively coupled to a storage device 120 over drive interface 150. Host system 110 includes workload manager 111 that also includes one or more tracking tables 112. Storage device 120 includes storage processor 121, media interface subsystem 122, and storage media 123. It should be noted that workload manager 111 can be included in other entities than host system 110. For example, a system separate from host system 110 might include workload manager 111, or workload manager 111 might be combined into other elements of FIG. 1.

In operation, workload manager 111 tracks and handles at least a portion of the low-level storage drive data management tasks, such as garbage collection, and other data migration tasks. Workload manager 111 has visibility to data operations directed to the storage drive with respect to storage operations of host system 110, and can thus intelligently interleave/schedule data operations with the data migration tasks to ensure enhanced operation of storage device 120. Since the data operations might include user data operations comprising user data writes, reads, and erases, workload manager 111 can improve the operation of storage device 120 with respect to user data operations as well. Specifically, garbage collection tasks (or other data migration tasks) can be deferred until user data operations have subsided below a threshold level of activity. Moreover, data migration tasks can take into account present or pending data operations to reduce write amplification.

Various tracking tables 112 are maintained by workload manager 111. Tables 112 can comprise one or more valid host block address tables that track how many valid host block addresses are present in each allocation unit of storage media 123, as well as one or more host block address to data block address translation tables for storage device 120. Workload manager 111 can track data migration processes of storage device 120 and initiate data migration tasks interleaved with normal data operations of storage device 120. Workload manager 111 determines when to migrate data and when to perform data storage operations, such as reads/writes. Workload manager 111 determines what actual data to migrate as well.

Workload manager 111 can indicate instructions 130 along with associated data blocks to storage device 120 that responsively indicates data block addresses. Responses 131 for write operations for data can communicate a sequence in which the data was received and written to the media by providing an identifier for workload manager 111 to later read the data written. This identifier can comprise an incrementing data block address. Responses 131 can also provide an indication to workload manager 111 that allows workload manager 111 to track which ranges of sequential data blocks correspond to individual allocation units. Using the incrementing identifier and indication related to ranges of sequential data blocks in allocation units, workload manager 111 can construct tables 112 to hold ranges of data block addresses, how many host data blocks are still valid in address ranges, and the host data block addresses for each valid host data block in the addresses ranges.

Furthermore, instructions 130 can include requests for media status from storage device 120. Requests for media status can inquire how many allocation units are left on storage media 123 before storage media 123 becomes full or exceeds a fullness threshold. This can be used by workload manager 111 to understand the urgency of garbage collection or other data migration activities. For example, when a quantity of allocation units are left exceeding a threshold quantity, then garbage collection prioritized over writing new data (e.g. data write operations). Thus, garbage collection can be delayed in lieu of writing new data. When a quantity of allocation units under a threshold quantity remain available or empty, garbage collection may be a higher priority than the writing of new data (e.g. data write operations).

Requests for media status can also inquire as to the estimated final data block address among the incrementing values. This final data block address can be specific to the storage media capacity, as well as related to how many allocation units are released and physical defects. This final data block address can be used by workload manager 111 to interleave data migrations with the writing of new data in an efficient manner, while still ensuring that enough data migration occurs to free up space on storage media 123 before storage media 123 becomes full or exceeds a fullness threshold. Instructions 130 can also indicate that an allocation unit may be erased and returned to an available pool of free allocation units by storage device 120.

In a further example, a virtual drive/core drive scheme can be employed. In FIG. 1, virtual drive 101 is shown along with core drive 102. Virtual drive 101 includes operations of workload manager 111 in the host system 110, and handles both data operations and data migration operations for storage device 120. Core drive 102 includes elements of storage device 120 that respond to the instructions of virtual drive 101 and perform data operations and data migration operations in accordance with workload manager instructions received over link 150. Since host system 110 via workload manager 111 has visibility to both user/host data operations and data migration/maintenance operations in these examples, enhanced scheduling and operation can be achieved for storage device 120. In contrast with conventional storage drives, the enhanced storage drives herein offload some of the data migration or data maintenance tasks to workload manager 111 in host system 120.

Returning to the elements of FIG. 1, host system 110 can comprise data management systems, end user devices, Internet systems, packet networks, data servers, application services, or other computing systems. Host system 110 also includes various circuitry and interface elements for communication over link 150. Host system 110 includes workload manager 111 in FIG. 1. Workload manager 111 can instead be included in other elements of FIG. 1, such as storage device 120. When included in host system 110, workload manager 111 and portions of host system 110 comprise virtual drive 101. Workload manager 111 comprises software, circuitry, interfaces, or processing elements configured to operate as described herein for a workload management layer. Workload manager 111 can include computer-executable instructions stored on a non-transitory computer-readable media, which are executed by host system 110 when read from the non-transitory computer-readable media. Workload manager 111 also comprises data storage elements for storing tables 112, such as non-volatile memory devices.

Processor 121 comprises a storage controller in this example, and may comprise a microprocessor and processing circuitry that retrieves and executes storage control software from one or more storage systems. Processor 121 may be implemented within a single processing device, but may also be distributed across multiple processing devices, sub-systems, or specialized circuitry, that cooperate in executing program instructions and in performing the operations discussed herein. Examples of processor 121 include general purpose central processing units, application specific processors, and logic devices, as well as any other type of processing device, combinations, or variations thereof. In some examples, processor 121 may be a Field Programmable Gate Array (FPGA) with software, software with a memory buffer, an Application Specific Integrated Circuit (ASIC) designed to be included in a single module with media interface 122, a set of Hardware Description Language (HDL) commands, such as Verilog or System Verilog, used to create an ASIC, a separate module from storage media 123, or any of many other possible configurations.

Processor 121 can also include host interface circuitry for communicating over link 150 with host system 110. Host interface circuitry includes one or more communication interfaces or network interfaces for communication over link 150. Host interface circuitry can include transceiver circuitry, buffer circuitry, protocol conversion circuitry, interface conversion circuitry, and other related circuitry. Link 150 might comprise peripheral component interconnect express (PCIe) links, serial AT attachment (SATA) links, NVM Express (NVMe) or Non-Volatile Memory Host Controller Interface Specification (NVMHCIS) links, universal serial bus (USB) links, HyperTransport (HT) links, InfiniBand links, FibreChannel links, Common Flash Memory Interface (CFI) links, Ethernet links, optical links, or wireless links.

Media interface 122 can include one or more Open NAND Flash Interface (ONFI) circuits (synchronous or asynchronous) or “toggle” command protocol interface circuits when NAND flash media is employed. Other interface types and compositions can be employed for other media types. Storage media 123 comprises one or more solid state storage media, such as NAND flash media, among other media types, including combinations thereof. Other examples of storage media include NOR flash, 3D XPoint storage, magnetic random-access memory (MRAM), phase-change memory (PCM), resistive random-access memory (ReRAM), memristor memory, optical disks, magnetic storage devices, hybrid disk drives, or any other suitable storage media.

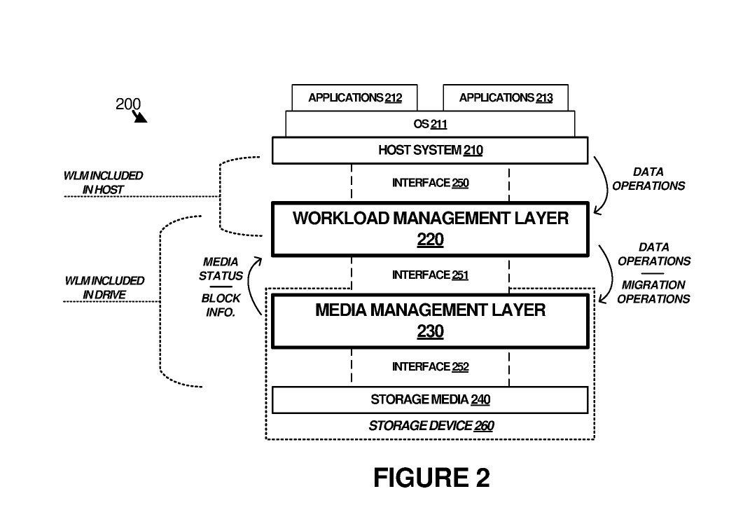

Turning now to a further example of enhanced storage device management, FIG. 2 is presented. FIG. 2 illustrates a data storage flow in an example implementation, namely system 200. System 200 includes a layered view of various storage control element, namely workload management layer 220 and media management layer 230. Host system 210 is included to illustrate an example system that can originate data operations, such as read/write/erase operations for data storage device 260. Storage media 240 is included to illustrate example physical media of storage device 260 upon which data is written for later retrieval. Interfaces 250-252 are provided to interconnect each of the various elements of system 200.

As noted in FIG. 2, workload management layer 220 and media management layer 230 can be included in similar elements or in different elements of a storage system. For example, workload management layer 220 might reside in elements of host system 210 or other elements external to host system 210 and storage device 260. In other examples, workload management layer 220 and media management layer 230 are both included in control system elements of storage device 260.

Host system 210 includes operating system (OS) 211 and applications 212-213. Operating system (OS) 211 and applications 212-213 can originate data storage operations, such as various read, write, trim, erase, or various filesystem operations which are directed to storage device 260. Storage device 260 can be similar to that discussed above for storage device 120 of FIG. 1, although only storage media 240 is shown in FIG. 2 for clarity. These data storage operations might originate in user applications, such as application 212-213, or might originate due to filesystem operations, caching operations, page swap operations, or other operations of OS 211. Other elements of host 210 can original these data storage operations, such as firmware, BIOS, maintenance elements, data encryption systems, data redundancy systems, and the like. These data storage operations can be transferred over interface 250, which might comprise a storage interface/link in examples where workload management layer 220 is included in a storage drive, or might comprise various programming interfaces, logical interfaces carried over storage interfaces, or application programming interfaces (APIs) when workload management layer 220 is included in host system 210.

Workload management layer 220 comprises layer of software or circuitry with knowledge of past, present, and future workloads of storage device 260. Workload management layer 220 can receive these data storage operations in some examples, and workload management layer 220 then handles execution of the data storage operations. In other examples, workload management layer 220 has visibility to the data storage operations, such as by inspecting operations contained in data storage operation queues of host system 210 or storage device 260. In further examples, workload management layer 220 might be provided with messaging that indicates present and upcoming/future data storage operations from host system 210 or storage device 260. Regardless of how workload management layer 220 gains visibility to the data storage operations, workload management layer 220 is configured to monitor past, present, and upcoming data storage operations.

Workload management layer 220 also manages data migration activities for storage media 240. Data migration activities include garbage collection, wear leveling, data staling avoidance, or other data/media maintenance activities for storage media 240. Workload management layer 220 interleaves data migration activities and data storage operations for storage media 240. Workload management layer 220 instructs execution of these data operations and data migration operations over interface 251 to media management layer 230. Interface 251 might comprise a storage interface/link in examples where workload management layer 220 is not included in storage drive 260, or might comprise various programming interfaces, logical interfaces carried over storage interfaces, or application programming interfaces (APIs) when workload management layer 220 is included in storage drive 260.

Media management layer 230 handles low-level physical access and interfacing with storage media 240. Media management layer 230 comprises a layer of software or circuitry with knowledge of how data needs to be written to non-volatile storage media, ensure that storage media wears evenly, handles storage media defects, and provides error correction capabilities for data stored on the storage media. In operation, media management layer 230 can provide media status information to workload management layer 220 so that workload management layer 220 can determine what data needs to be migrated, and when data migration needs to occur. Moreover, media management layer 230 provides data block information to workload management layer 220 responsive to storage operations transferred by workload management layer 220.

Media management layer 230 might comprise control and interfacing elements, such as ONFI interfaces, toggle-style interfaces, or other non-volatile storage media interfaces. Storage media 240 can comprise physical storage elements, such as NAND flash arrays or other storage elements. Thus, interface 252 comprises one or more interfaces to individual storage media elements, such as NAND flash chips, wafers, dies, or other storage media.

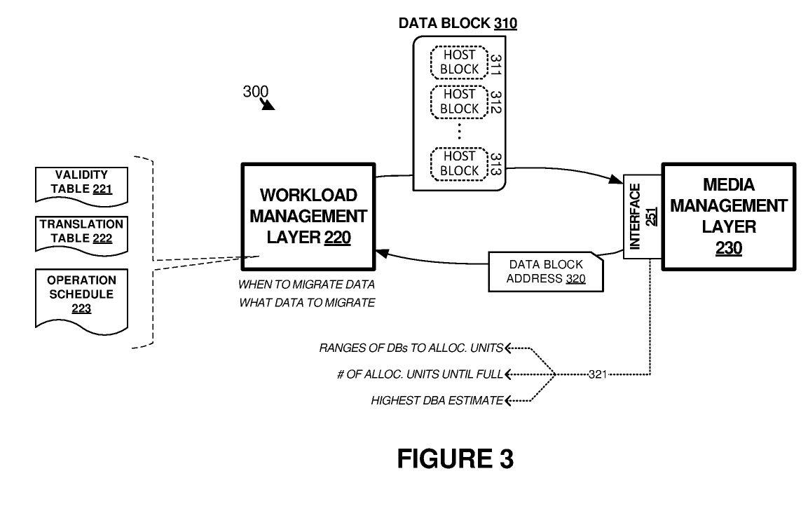

FIG. 3 is presented to further detail example operations of elements of FIG. 2. FIG. 3 includes configuration 300 which highlights workload management layer 220 and media management layer 230 which communicate over interface 251. Other elements of FIG. 2 are omitted from FIG. 3 for clarity.

Various terminology is employed in the discussion herein. Storage media 240 can be managed by writing to groups of logical blocks, sometimes known as superblocks and referred to herein as to allocation units (AUs). An allocation unit refers to a granular unit at which media management layer 230 allocates storage media 240 for writing new data and erasing invalidated data. A host block (HB) refers to a granular block of data from the perspective of host system 210, such as a sector of data. A host block address (HBA) refers to a sector number and indicates a particular HB. A data block (DB) comprises an arbitrary quantity of HBs, and thus refers to a grouping of HBs. Each DB will have a corresponding data block address (DBA) that comprises an increasing number that identifies a DB in the order that it was written to storage media 240. Invalid data comprises HBs that reside in a DB, but are no longer valid because new copies of the same HBA have been written to DBs with a higher DBA.

In operation, workload management layer 220 packs host blocks (HBs) into data blocks (DBs) and sends them to media management layer 230 to write to physical media. In FIG. 3, a plurality of HBs 311-313 are grouped into DB 310 by workload management layer 220, and transferred over interface 251 to media management layer 230. Media management layer 230 responds with data block address (DBA) 320, which communicates the sequence in which DB 310 was received and written to the physical media. DBAs comprise numbers/indicators which are incremented sequentially responsive to each DB received for storage. DBA 320 comprises an identifier for workload management layer 220 to retrieve/read the data associated with DB 310. Media management layer 230 also provides an indication to workload management layer 220 that allows it to understand which ranges of sequential DBs correspond to individual allocation units.

Using the information provided by media management layer 230, such as DBAs and ranges of sequential DBs correspond to individual allocation units, workload management layer 220 can construct one or more tracking tables. These tables comprise data structures that indicate ranges of DBAs, indicate how many HBs are still valid in the ranges, and indicate the HBAs for each valid HB in the range. Validity table 221 is shown in FIG. 3 as an example data structure alone these lines. A translation table 222 can be maintained by workload management layer 220, which comprises one or more “HBA-to-DBA translation” data structures. Operations schedule 223 can also be established by workload management layer 220 to track data migration tasks and data storage tasks. Operations schedule 223 can comprise a queue or ordered list which indicates ordering among data migration tasks and data storage tasks for execution by media management layer 230. With at least operations schedule 223, workload management layer 220 can track data migration processes and initiate data migration tasks interleaved with normal data operations of the storage drive. Workload management layer 220 can indicate instructions along with DBAs to media management layer 230 that indicate one or more DBAs, the DBAs can each correspond to an incrementing number/indicator.

Interface 251 or interfacing elements of media management layer 230 provide an interface where media management layer 230 can communicate various information 321 to workload management layer 220. This information 321 can include a fullness indicator that indicates how many allocation units remain available (such as unused or free) before storage media 240 becomes full. This fullness indicator can be used by workload management layer 220 to understand the urgency of garbage collection or other data migration activities. For example, when many allocation units remain available, garbage collection might be unnecessary or can be delayed until the fullness indicator reaches a fullness threshold level. When only a few allocation units remain available, garbage collection or other data migration activities may be higher priority than the writing of new data.

This information 321 provided by media management layer 230 can also include an estimated final DBA. Media management layer 230 can estimate the highest DB number that can be supported if no allocation units are released and no grown defects are encountered. This estimated final DBA can be used by workload management layer 220 to interleave data migrations with the writing of new data, while still ensuring that enough data migration (such as garbage collection) occurs to free up media space before the storage media becomes full based on the estimated final DBA. Thus, as DBAs are received by workload management layer 220 responsive to write operations, workload management layer 220 can estimate how many more DBs can be written before the storage media is full or exceeds a fullness threshold.

Interface 251 or interfacing elements of media management layer 230 can also provide an interface where an allocation unit may be erased and returned to the available pool of allocation units. Thus, workload management layer 220 can indicate to media management layer 230 to erase an allocation unit or return an allocation unit to an available pool of allocation units. This scheme allows workload management layer 220 to be fully in control of when to migrate data and what data to migrate based on workload (e.g. data storage operations). For example, workload management layer 220 can choose to migrate data during times that workload management layer 220 is not receiving commands to read data or write new data from host system 210. Workload management layer 220 can choose not to migrate data at all, if workload management layer 220 has knowledge that new data writes from host system 210 will invalidate allocation units without migration. Workload management layer 220 can interleave reads and writes of new data from host system 210 with migrations in a way that satisfies the needs of the workload with regard to latency and throughput of the reads and writes.

Workload management layer 220 can thus make intelligent choices about what data to migrate and when to migrate data based on past, current, and future storage operation workloads initiated by host system 210. However, workload management layer 220 still relies upon media management layer 230 to understands various reasons data must be moved based on the characteristics of the physical media. Therefore, further interfacing among media management layer 230 and workload management layer 220 can be defined, where media management layer 230 can either asynchronously notify workload management layer 220 (or be queried by workload management layer 220) regarding ranges of DBAs that should be moved for the purposes of wear leveling, or due to data retention or read disturb concerns. While media management layer 230 informs workload management layer 220 what data needs to be moved for data migration purposes, media management layer 230 still allows workload management layer 220 to control when to move data for data migration purposes, or even to delay or omit movement of data for data migration purposes if such data will be re-written in the near future, based on pending or anticipated storage operations from host system 210.

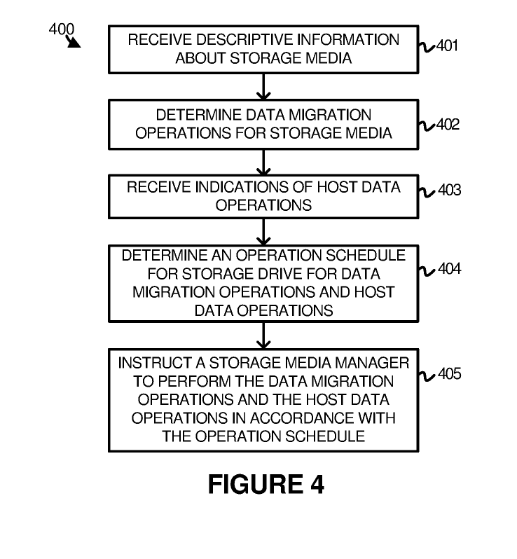

To further illustrate operations of workload management layer 220, FIG. 4 is presented. FIG. 4 illustrates method 400 of operating a data storage system in an example implementation. The operations of FIG. 4 can be applied to elements of FIGS. 1-3, although in this example will be discussed in the context of workload management layer 220.

In FIG. 4, workload management layer 220 receives (401) descriptive information about storage media 240. This descriptive information can relate to data migration tasks or activities that need to be performed for storage media 240. In this example, workload management layer 220 receives this information from media management layer 230 via interface 251. This information indicates ranges of DBAs that should be moved for the purposes of wear leveling, or due to data retention or read disturb concerns, among other data migration processes. Moreover, this information can include garbage collection information for data on storage media 240 that has been trimmed. Further information 321 can be provided to workload management layer 220 so that workload management layer 220 can maintain a status of data migration tasks that need to be performed for storage media 240. With at least this information workload management layer 220 determines (402) data migration operations for storage media 240. As mentioned above, these data migration operations can include moving data from one portion of storage media 240 to another portion, from one allocation unit to another allocation unit, or according to other migration partitioning.

In addition to data migration information received from media management layer 230, workload management layer 220 also receives (403) indications of host data operations. These indication of host data operations can be received from host system 210 over interface 250. Host system 210 can transfer these indications, or workload management layer 220 might instead check or query data operation queues associated with host system 210. In yet further examples, workload management layer 220 is included in a data storage device and any storage operations received over a storage interface from host system 210 are monitored by workload management layer 220. These storage operations can include write operations, read operations, erase/trim operations, filesystem operations, or other various data operations issued by host system 210. Associated data for storage can accompany write operations.

Once workload management layer 220 has visibility to data migration information for storage media 240 and indications of host data operations, then workload management layer 220 determines (404) an operation schedule 223 for storage drive 260 for data migration operations and host data operations. This operation schedule 223 includes timewise task organization among data migration operations and host data operations, which are instructed by workload management layer 220 for control of media management layer 230. Thus, instructs (405) a storage media manager (media management layer 230) to perform the data migration operations and the host data operations in accordance with the operation schedule.

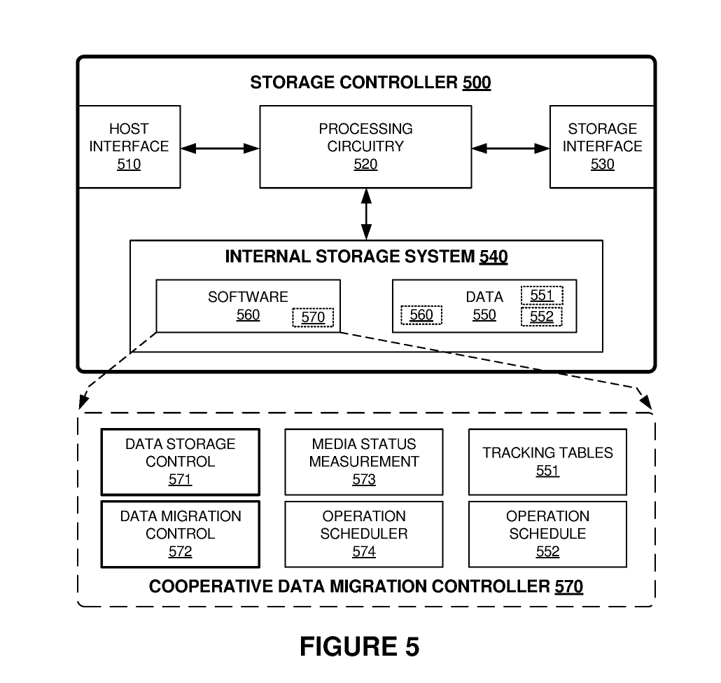

FIG. 5 illustrates storage controller 500. Storage controller 500 may take on any of a wide variety of configurations, and can form elements discussed herein for workload manager 111, processor 121, or media interface of FIG. 1. Moreover, storage controller 500 can form elements discussed herein for workload management layer 220, media management layer 230, and interfaces 250-252. Here, an example configuration is provided for a storage controller implemented as an ASIC or field programmable gate array (FPGA). However, in other examples, storage controller 500 may be built into a storage device, storage drive, storage system, or storage array, or incorporated into a host system.

In this example, storage controller 500 comprises host interface 510, processing circuitry 520, storage interface 530, and internal storage system 540. Host interface 510 comprises circuitry configured to receive data and commands from external host systems and to send data to the host systems. Storage interface 530 comprises circuitry configured to send data and commands to storage media and to receive data from the storage media.

Processing circuitry 520 comprises electronic circuitry configured to perform the tasks of a storage controller as described above. Processing circuitry 520 may comprise microprocessors and other circuitry that retrieves and executes software 560. Processing circuitry 520 may be embedded in a storage system in some examples. Examples of processing circuitry 520 include general purpose central processing units, application specific processors, and logic devices, as well as any other type of processing device, combinations, or variations thereof. Processing circuitry 520 can be implemented within a single processing device but can also be distributed across multiple processing devices or sub-systems that cooperate in executing program instructions.

Internal storage system 540 can comprise any non-transitory computer readable storage media capable of storing software 560 that is executable by processing circuitry 520. Internal storage system 540 can also include various data structures 550 which comprise one or more databases, tables, lists, or other data structures. Storage system 540 can include volatile and nonvolatile, removable and non-removable media implemented in any method or technology for storage of information, such as computer readable instructions, data structures, program modules, or other data.

Storage system 540 can be implemented as a single storage device but can also be implemented across multiple storage devices or sub-systems co-located or distributed relative to each other. Storage system 540 can comprise additional elements, such as a controller, capable of communicating with processing circuitry 520. Examples of storage media include random access memory, read only memory, magnetic storage, optical storage, flash memory, virtual memory and non-virtual memory, or any other medium which can be used to store the desired information and that can be accessed by an instruction execution system, as well as any combination or variation thereof.

Software 560 can be implemented in program instructions and among other functions can, when executed by storage controller 500 in general or processing circuitry 520 in particular, direct storage controller 500, or processing circuitry 520, to operate as described herein for a storage controller. Software 560 can include additional processes, programs, or components, such as operating system software, database software, or application software. Software 560 can also comprise firmware or some other form of machine-readable processing instructions executable by elements of processing circuitry 520.

In at least one implementation, the program instructions can include cooperative data migration controller 570. Cooperative data migration controller 570 is configured to enable cooperative storage media management among workload management layers and media management layers. In this example, workload management layers are at least in part represented by data storage control 571 and data migration control 572. Cooperative data migration controller 570 includes data storage control 571, data migration control 572, media status measurement 573, and operation scheduler 574. Also, various data structures are included to support the operations of data storage control 571, data migration control 572, media status measurement 573, and operation scheduler 574. These data structures include tracking tables 551 and operation schedule 552. Tracking tables 551 and operation schedule 552 can be stored in non-volatile storage and moved to a cache or RAM during operation of cooperative data migration controller 570.

Data storage control 571 includes instructions to handle tracking of data storage operations issued by a host system for a storage drive. These data storage operations can include past, present, pending, or future data storage operations. Data storage operations can include writes, reads, erases, trims, or other data storage operations, along with associated data. Data storage control 571 can track addressing, data sizes, and other properties of the data storage operations in a portion of tracking tables 551. Data migration control 572 includes instructions to handle execution data migration tasks, which might include garbage collection tasks, wear leveling tasks, data staling avoidance, or other maintenance activities for a storage media. Media status measurement 573 includes instructions to handle tracking information related to data migration tasks, such as media fullness status, garbage collection status and pending garbage collection tasks, trim operations, and media addressing associated with such tasks. Media status measurement 573 can receive data migration information from a media controller or can obtain this information internally when media status measurement 573 is included in media interfacing elements. Operation scheduler 574 includes instructions to determine scheduling among data storage operations and data migration operations. Operation scheduler 574 can optimize scheduling among data storage operations and data migration operations to reduce the impact of data migration operations on performance, latency, or throughput of data storage operations. Moreover, operation scheduler 574 can delay or omit certain data migration tasks when the physical storage media is below fullness thresholds or data staling metrics fall below target levels for certain allocation units. Operation scheduler 574 can thus provide enhanced execution of both data storage operations and data migration for a storage media. Operation scheduler 574 can maintain a queue or task list using operation schedule 552, as discussed herein.

In general, software 560 can, when loaded into processing circuitry 520 and executed, transform processing circuitry 520 overall from a general-purpose computing system into a special-purpose computing system customized to operate as described herein for a storage controller, among other operations. Encoding software 560 on internal storage system 540 can transform the physical structure of internal storage system 540. The specific transformation of the physical structure can depend on various factors in different implementations of this description. Examples of such factors can include, but are not limited to, the technology used to implement the storage media of internal storage system 540 and whether the computer-storage media are characterized as primary or secondary storage.

For example, if the computer-storage media are implemented as semiconductor-based memory, software 560 can transform the physical state of the semiconductor memory when the program is encoded therein. For example, software 560 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above may be combined in various ways to form multiple embodiments. As a result, the invention is not limited to the specific embodiments described above, but only by the claims and their equivalents.

What is claimed is:

1. A storage system, comprising:
a workload manager with visibility to host data operations for a storage drive, the workload manager configured to determine an operation schedule comprising the host data operations and data migration operations for storage media of the storage drive, and instruct a storage media manager to perform the data migration operations and the host data operations in accordance with the operation schedule; and
the storage media manager configured to receive instructions from the workload manager in accordance with the operation schedule, and responsively perform the data migration operations and the host data operations.

2. The storage system of claim 1, wherein the operation schedule comprises ones of the data migration operations interleaved with ones of the host data operations.

3. The storage system of claim 1, comprising:
the workload manager configured to determine when to perform the data migration operations based at least on addressing properties of the host data operations.

4. The storage system of claim 3, wherein the data migration operations affect storage allocation units of the storage media indicated by the addressing properties of the host data operations.

5. The storage system of claim 1, comprising:
the workload manager configured to determine data to migrate among the data migration operations based at least on properties of the host data operations.

6. The storage system of claim 5, wherein the host data operations affect portions of the data indicated by the data migration operations.

7. The storage system of claim 1, comprising:
the workload manager configured to track data written to the storage media using at least data block addresses sequentially incremented by the storage media manager and responsive to data write operations submitted to the storage media manager by the workload manager.

8. The storage system of claim 7, comprising:
the workload manager configured to receive indications of data locations affected by the data migration operations from the storage media manager, and responsively compare the data locations to the data block addresses of the data write operations to determine at least a portion of the operation schedule.

9. The storage system of claim 1, comprising:
the workload manager configured to receive one or more indications of storage media properties from the storage media manager, wherein the one or more indications comprise at least one among indications of data locations affected by the data migration operations, a quantity of free data allocation units remaining on the storage media, and estimated final data block addressing for write operations to the storage media; and
the workload manager configured to determine the operation schedule based at least in part on the one or more indications of storage media properties.

10. The storage system of claim 8, comprising:
the workload manager configured to prioritize at least write operations among the host storage operations above garbage collection tasks among the data migration operations until the host data operations fall below a threshold activity level or until the quantity of free data allocation units remaining on the storage media fall below a threshold fullness level.

11. A method of operating a storage controller, the method comprising:
in a workload manager with visibility to host data operations for a storage drive, determining an operation schedule comprising interleaved ones of the host data operations and data migration operations for storage media of the storage drive; and
in the workload manager, instructing a storage media manager to perform the data migration operations and the host data operations in accordance with the operation schedule.

12. The method of claim 11, comprising:
in the workload manager determining when to perform the data migration operations based at least on addressing properties of the host data operations.

13. The method of claim 12, wherein the data migration operations affect storage allocation units of the storage media indicated by the addressing properties of the host data operations.

14. The method of claim 11, comprising:
in the workload manager, determining data to migrate among the data migration operations based at least on properties of the host data operations.

15. The method of claim 14, wherein the host data operations affect portions of the data indicated by the data migration operations.

16. The method of claim 11, comprising:
in the workload manager, tracking data written to the storage media using at least data block addresses sequentially incremented by the storage media manager and responsive to data write operations submitted to the storage media manager by the workload manager.

17. The method of claim 16, comprising:
in the workload manager, receiving indications of data locations affected by the data migration operations from the storage media manager, and responsively comparing the data locations to the data block addresses of the data write operations to determine at least a portion of the operation schedule.

18. The method of claim 11, comprising:
in the workload manager, receiving one or more indications of storage media properties from the storage media manager, wherein the one or more indications comprise at least one among indications of data locations affected by the data migration operations, a quantity of free data allocation units remaining on the storage media, and estimated final data block addressing for write operations to the storage media; and
in the workload manager, determining the operation schedule based at least in part on the one or more indications of storage media properties.

19. The method of claim 18, comprising:
in the workload manager, prioritizing at least write operations among the host storage operations above garbage collection tasks among the data migration operations until the host data operations fall below a threshold activity level or until the quantity of free data allocation units remaining on the storage media fall below a threshold fullness level.

20. An apparatus comprising:
one or more computer readable storage media;
program instructions stored on the one or more computer readable storage media that, when executed by a processing system, direct the processing system to at least:
monitor data operations for a storage drive;
receive indications of properties of data migration operations that affect a storage media of the storage drive;
determine an operation schedule comprising one or more of the host data operations and one or more of the data migration operations for the storage media of the storage drive; and
instruct a storage media manager to perform the data migration operations and the host data operations in accordance with the operation schedule.
